(19) United States
(12) Patent Application Publication
(10) Pub. No.: US 2026/0088569 A1
(43) Pub. Date: Mar. 26, 2026

(54) CONNECTOR

(71) Applicant: SUMITOMO WIRING SYSTEMS, LTD., Mie (JP)

(72) Inventor: Junya MATSUURA, Mie (JP)

(21) Appl. No.: 19/111,282

(22) PCT Filed: Aug. 31, 2023
(86) PCT No.: PCT/JP2023/031672

§ 371 Date: Mar. 12, 2025

(30) Foreign Application Priority Data
Sep. 21, 2022 (JP) 2022-149932

(51) Int. Cl. H01R 13/639

(52) U.S. Cl. CPC H01R 13/639

(57) ABSTRACT

A housing (20) has a housing body (28) and a locking arm (31). The locking arm (31) has a base end portion (38) coupled to an end portion of the housing body (28) on a front side, an arm body (39) extending rearwardly in a cantilever manner from the base end portion (38) and having a free end portion (42) on a rear end side, and a locking part (41) provided in an intermediate position of the arm body (39) in the front-back direction and lockable to a partner locking part (82) of a partner housing (80). The housing body (28) has a contacting part (51) on a center-side upper surface part (32) which is an upper surface thereof and comes in contact with the free end portion (42) of the arm body (39) in a mating process.

### TECHNICAL FIELD

The present disclosure relates to a connector.

### BACKGROUND

A connector disclosed in Patent Document 1 is provided with a female connector housing and a male connector housing that are mateable together. The female connector housing is provided with a locking arm. The locking arm has a shape extending rearwardly in a cantilever manner from a support leg coupled to an upper surface of the female connector housing. In the process of mating both connector housings, the locking arm is elastically displaced. A rear end portion of the locking arm approaches the upper surface of the female connector housing but does not come in contact with the upper surface of the female connector housing. When mating both connector housings, the locking arm elastically returns with a predetermined elastic reaction force and is locked to the male connector housing. Both connector housings are thereby held in a mated state. When unlocking the locking arm, the rear end portion of the locking arm is pressed downward. In the case of Patent Document 1, the rear end portion of the locking arm is pushed down to a limit position and comes in contact with the upper surface of the female connector housing. Connectors with locking arms are also disclosed in Patent Documents 2 and 3.

### PRIOR ART DOCUMENT

### Patent Document

Patent Document 1: JP H09-055259 A

Patent Document 2: JP 2001-250636 A

Patent Document 3: JP 2006-179266 A

### SUMMARY OF THE INVENTION

### Problems to be Solved

Incidentally, in the case where the locking arm extends rearwardly from a base end portion on the front end side (support leg of Patent Document 1) in a cantilever manner as in Patent Document 1, there is concern that stress will be concentrated at the base end portion when the locking arm is elastically displaced in the connector mating process. For example, there is concern that the base end portion will break when the thickness (section modulus) of the base end portion decreases due to miniaturization of the connector.

In contrast, if the locking arm is formed in a double-supported beam shape in which both front and rear ends are coupled to a body portion of the housing, stress can be distributed on both front and rear end sides of the locking arm. Furthermore, if the locking arm is formed in a double-supported beam shape, the elastic reaction force of the locking arm at the time of mating the connectors can be enhanced, and the locking feel can be improved. However, there is concern that when the elastic reaction force of the locking arm becomes too high stress will be concentrated on both front and rear end sides of the locking arm, resulting in a deterioration of operability due to excessive mating resistance.

In view of this, an object of the present disclosure is to provide a connector that is able to avoid concentration of stress at a base end portion of a locking arm and is capable of improving the locking feel.

### Means to Solve the Problem

A connector of the present disclosure includes a housing mateable to a partner housing, the housing including an elastically displaceable locking arm that holds the partner housing and the housing in a mated state and a housing body having one surface opposing the locking arm in a direction in which the locking arm is elastically displaced in a process of mating the housing and the partner housing, and, where a front side is a front side in a mating direction of the housing to the partner housing, the locking arm including a base end portion coupled to an end portion of the housing body on the front side, an arm body extending rearwardly from the base end portion in a cantilever manner and having a free end portion on a rear end side, and a locking part provided in an intermediate portion of the arm body in a front-back direction and lockable to a partner locking part of the partner housing, and the housing body including, on the one surface, a contacting part that comes in contact with the free end portion of the arm body in the mating process.

### Effect of the Invention

According to the present disclosure, a connector that is able to avoid concentration of stress at a base end portion of a locking arm and is capable of improving the locking feel can be provided.

### BRIEF DESCRIPTION OF THE DRAWINGS

FIG. 1 is a cross-sectional view showing a state in which a housing is mated to a partner housing in a connector according to a first embodiment of the present disclosure.

FIG. 2 is a perspective view of the housing.

FIG. 3 is a rear view of the housing.

FIG. 4 is an enlarged cross-sectional view showing a portion of a locking arm of the housing.

FIG. 5 is a diagram corresponding to FIG. 4 showing a state in which sliding of a locking part of the locking arm and a partner locking part has started.

FIG. 6 is a diagram corresponding to FIG. 4 showing a state in which the locking arm is elastically displaced to the maximum.

FIG. 7 is a partially enlarged view of FIG. 1.

### DETAILED DESCRIPTION TO EXECUTE THE INVENTION

### Description of Embodiments of Disclosure

Initially, modes of the present disclosure will be enumerated and described.
(1) A connector of the present disclosure is a connector including a housing mateable to a partner housing, in which the housing includes an elastically displaceable locking arm that holds the partner housing and the housing in a mated state and a housing body having one surface opposing the locking arm in a direction in which the locking arm is elastically displaced in a process of mating the housing and the partner housing, and, where a front side is a front side in a mating direction of the housing to the partner housing, the locking arm includes a base end portion coupled to an end portion of the housing body on the front side, an arm body extending rearwardly from the base end portion in a cantilever manner and having a free end portion on a rear end side, and a locking part provided in an intermediate portion of the arm body in a front-back direction and lockable to a partner locking part of the partner housing, and the housing body includes, on the one surface, a contacting part that contacts the free end portion of the arm body in the mating process.

According to the above configuration, in the process of mating the housing and the partner housing, stress acting on the locking arm is distributed on the base end portion side and the free end portion side, and thus concentration of stress on only the base end portion side can be avoided.

Also, the free end portion of the arm body comes in contact with the contacting part but is not integrated with the contacting part, thus enabling stress acting on the free end portion side to be suppressed, and an excessive increase in the elastic reaction force of the locking arm can be avoided. As a result, a favorable locking feel can be obtained when mating the housing and the partner housing.
(2) Preferably, the contacting part is configured to come in contact with the free end portion from a state in which the arm body is elastically displaced on the one surface side in the mating process.

According to the above configuration, the mating resistance of the connector can be suppressed while the free end portion of the arm body is in contact with the contacting part.
(3) The contacting part preferably protrudes from the one surface.

According to the above configuration, the timing at which the free end portion of the arm body comes in contact with the contacting part and the contact resistance between the free end portion and the contacting part can be easily adjusted simply by, for instance, changing the amount by which the contacting part protrudes.
(4) Preferably, the arm body includes an unlocking operation part protruding from an opposite side to the one surface side, between the free end portion and the locking part in the front-back direction.

When the free end portion of the arm body is configured to come in contact with the contacting part, as in the present disclosure, the locking arm cannot be unlocked even if the free end portion side part is pressed, and thus the housing and the partner housing cannot be separated. In that regard, according to the above configuration, the unlocking operation part is disposed between the free end portion of the arm body and the locking part, and thus the locking arm can be unlocked by pressing the unlocking operation part, and the housing and the partner housing can be separated.

### Detailed Description of Embodiments of Disclosure

Specific examples of the present disclosure will be described below with reference to the drawings. Note that the present invention is not limited to these illustrative examples and is indicated by the claims, and all changes that come within the meaning and range of equivalency of the claims are intended to be embraced therein.

### First Embodiment

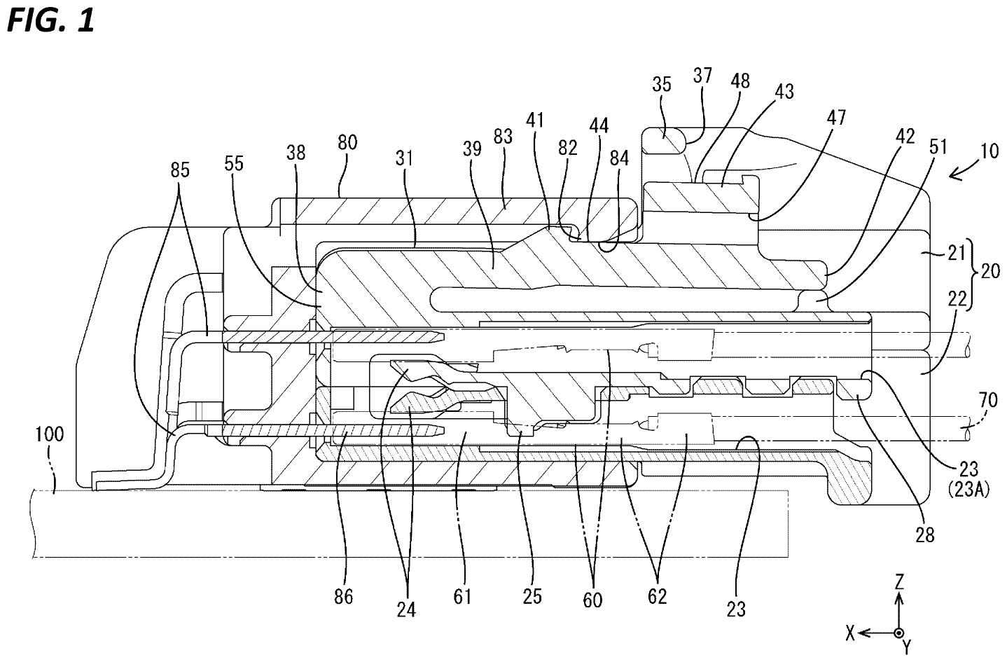

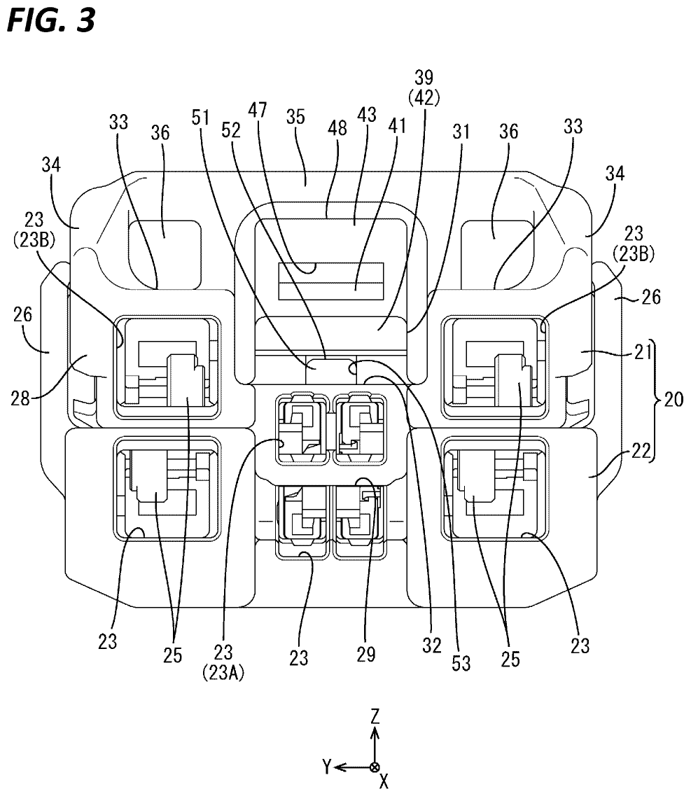

A connector 10 according to a first embodiment of the present disclosure includes a housing 20 and terminal fittings 60 that are housed in the housing 20, as shown in FIG. 1. The housing 20 is mated to a partner housing 80. Note that, in the following description, the side on which the housing 20 is mated to the partner housing 80 is the front side in the front-back direction. The front side (see reference numeral X in FIGS. 1 to 3) is the left side in FIG. 1. The up-down direction is based on the up-down direction in FIG. 1. An upper side (see reference numeral Z in FIGS. 1 to 3) is the upper side in FIG. 1. The up-down direction is synonymous with a height direction. The left-right direction is based on the left-right direction as viewed from the front side. The right side (see reference numeral Y in FIG. 1 to 3) is the left side in FIG. 3 in which the housing 20 is viewed from the rear. The left-right direction is synonymous with a width direction. These directions are for the sake of convenience and do not necessarily coincide with the directions in a state where the connector 10 is installed in a vehicle or the like not shown.

Also, in the following description, mating of the housing 20 and the partner housing 80 is synonymous with completion of mating of the housing 20 and the partner housing 80. The process of mating the housing 20 and the partner housing 80 refers to the period from the start of mating of the housing 20 and the partner housing 80 to the completion of mating, and does not include the mating start time or the mating completion time.

### Partner Housing

The partner housing 80 is made of synthetic resin and, as shown in FIG. 1, is disposed on the surface of a circuit board 100. The partner housing 80 has a tubular shape, and a partner terminal fitting 85 is mounted to an inner back wall thereof. The partner terminal fitting 85 has a terminal connecting part 86 that is pin or tab shaped and protrudes inside the partner housing 80. The partner terminal fitting 85 is bent outside the partner housing 80 and connected to the circuit board 100 by soldering. A partner locking part 82 is formed protruding on an inner surface of an upper wall 83 of the partner housing 80.

### Housing and Terminal Fittings

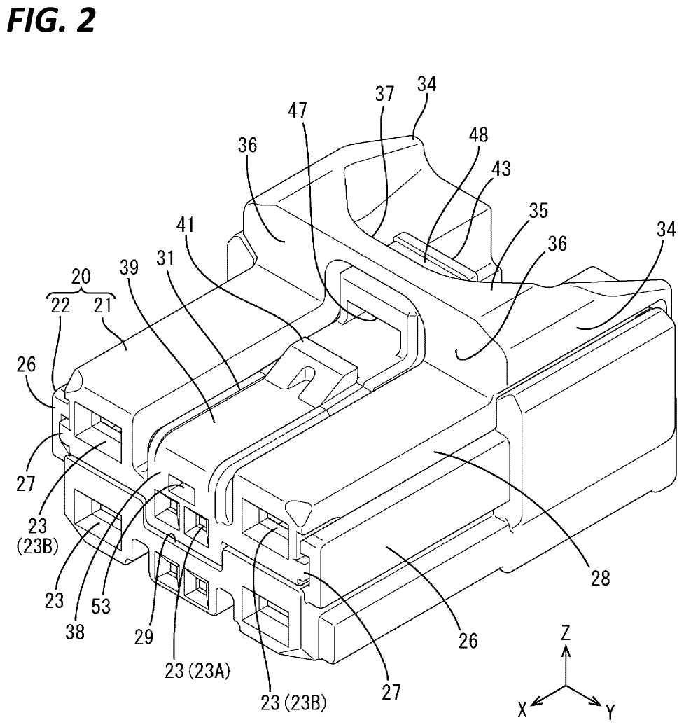

The housing 20 is made of synthetic resin and is constituted by an upper-side housing 21 and a lower-side housing 22 that are stacked in the up-down direction. As shown in FIGS. 2 and 3, the upper-side housing 21 and the lower-side housing 22 have a plurality of cavities 23 arranged in the left-right direction. Also, as shown in FIG. 1, the upper-side housing 21 and the lower-side housing 22 have a lance 24 protruding on the inside of each cavity 23 and a retainer part 25 disposed corresponding to each cavity 23. The retainer part 25 of the upper-side housing 21 enters the cavity 23 of the lower-side housing 22 with assembly of the upper-side housing 21 and the lower-side housing 22. The retainer part 25 of the lower-side housing 22 enters the cavity 23 of the upper-side housing 21 with assembly of the upper-side housing 21 and the lower-side housing 22.

Before assembly of the upper-side housing 21 and the lower-side housing 22, the terminal fitting 60 is inserted into each cavity 23 of the upper-side housing 21 and the lower-side housing 22 from the rear. The terminal fitting 60 inserted into each cavity 23 is primary-locked by the lance 24.

As shown in FIG. 1, after assembly of the upper-side housing 21 and the lower-side housing 22, the terminal fitting 60 inserted into each cavity 23 of the lower-side housing 22 is secondary-locked by the retainer part 25 of the upper-side housing 21. Similarly, the terminal fitting 60 inserted into each cavity 23 of the upper-side housing 21 is secondary-locked by the retainer part 25 of the lower-side housing 22, and the terminal fittings 60 are housed in a retained state in the upper-side housing 21. Also, after assembly of the upper-side housing 21 and the lower-side housing 22, the lances 24 of the upper-side housing 21 and the lances 24 of the lower-side housing 22 respectively face each other in a back-to-back state, and flexing movement of the lances 24 is inhibited. The terminal fittings 60 are thereby held in a retained state in the upper-side housing 21 and the lower-side housing 22.

As shown in FIG. 2, the lower-side housing 22 has a pair of locking pieces 26 protruding upwardly from end portions on both left and right sides. The upper-side housing 21 has a locking rib 27 at a position corresponding to each locking piece 26 on end faces on both left and right sides. The assembled state (stacked state) of the upper-side housing 21 and the lower-side housing 22 is held, by the locking pieces 26 locking the locking ribs 27.

The terminal fitting 60 is a female terminal made of a conductive metal and, as shown in FIG. 1, has a tubular box part 61 and a barrel part 62 disposed rearward of the box part 61. When mating the housing 20 and the partner housing 80, the box part 61 accepts the terminal connecting part 86 of the partner terminal fitting 85 and is electrically connected to the partner terminal fitting 85. The barrel part 62 is electrically and mechanically connected to the terminal part of the wire 70 by crimping.

The upper-side housing 21 (housing 20) has a housing body 28 having the cavities 23, the lances 24, and the retainer parts 25, and a locking arm 31 protruding from the housing body 28. As shown in FIGS. 2 and 3, in the housing body 28, cavities 23A in the center in the left-right direction (intermediate side in left-right direction) are disposed at a position lower than cavities 23B on both left and right sides. The lower-side housing 22 has, at a position corresponding to the cavities 23A in the left-right center, a mating recessed part 29 that fits the lower end portion of the cavities 23A.

As shown in FIG. 3, the upper surface (one surface) of the housing body 28 has a center-side upper surface part 32 corresponding to the center cavities 23A and a pair of edge-side upper surface parts 33 corresponding to the cavities 23B on both left and right sides. The center-side upper surface part 32 is disposed one step lower than the edge-side upper surface parts 33.

As shown in FIGS. 2 and 3, the housing body 28 has a sidewall part 34 protruding upwardly from an end portion of each edge-side upper surface part 33, a covering wall part 35 bridging between upper ends of the sidewall parts 34, and a pair of blocking walls 36 extending upwardly from the edge-side upper surface parts 33 and coupled to the sidewall parts 34 and the covering wall part 35. The sidewall parts 34 are formed on the rear side of the housing body 28. As shown in FIG. 2, an evacuation part 37 that is recessed in a curved shape in plan view is formed at the rear end of the covering wall part 35.

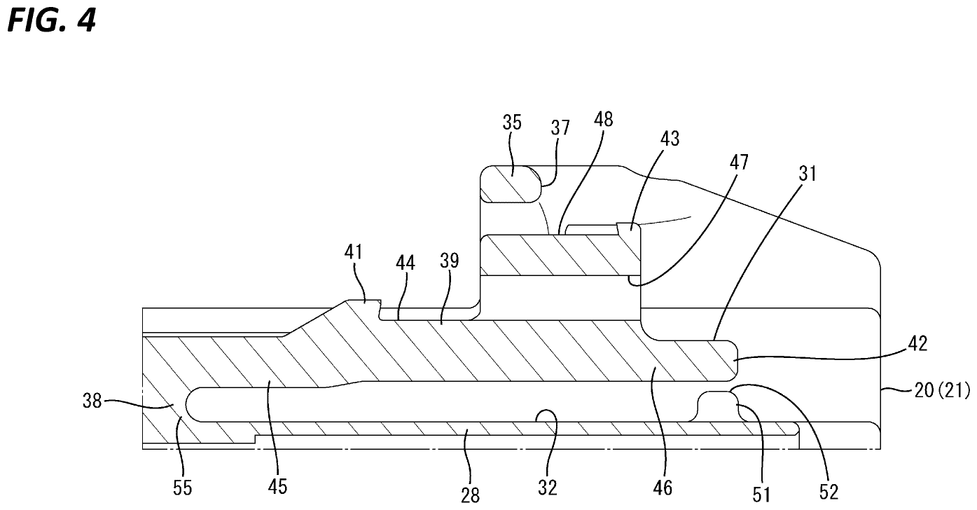

As shown in FIG. 4, the locking arm 31 has a base end portion 38 that extends upwardly from a front end portion of the center-side upper surface part 32 and an arm body 39 that extends rearwardly from the upper end side of the base end portion 38. Also, the locking arm 31 has a locking part 41 protruding upwardly from an intermediate position of the arm body 39 in the right-left direction, a free end portion 42 located at the rear end portion, and an unlocking operation part 43 protruding upwardly from a position between the free end portion 42 and the locking part 41 in the front-back direction.

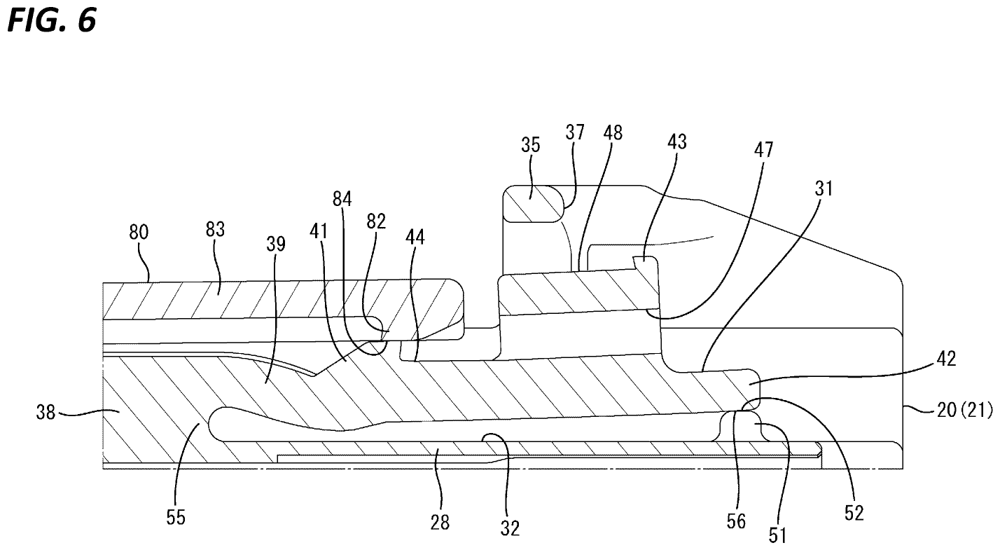

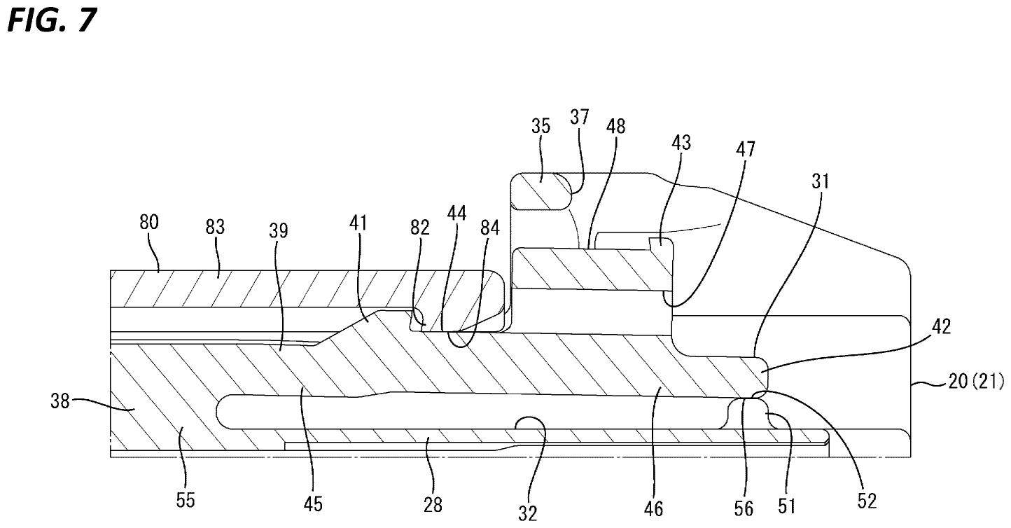

As shown in FIG. 6, in the process of mating the housing 20 and the partner housing 80, the locking arm 31 is elastically displaced in a direction in which an intermediate portion (portion corresponding to locking part 41) of the arm body 39 in the front-back direction approaches the center-side upper surface part 32, which is the upper surface of the housing body 28, with a front end region 55 including the base end portion 38 and a rear end region 56 described later as supporting points. When mating of the housing 20 and the partner housing 80 is completed, the locking arm 31 is elastically restored, the arm body 39 rises toward its original position, and a striking surface 44 adjacent to the locking part 41 on the upper surface of the arm body 39 strikes the partner locking part 82 of the partner housing 80, and the locking part 41 is disposed in a manner lockable to the partner locking part 82 (see FIG. 7). The housing 20 and the partner housing 80 are thereby held in the mated state.

The arm body 39 and the base end portion 38 are plate shaped and, as shown in FIG. 2, have a constant width dimension in the left-right direction. As shown in FIG. 4, the arm body 39 has a front part 45 and a rear part 46 on both front and rear sides with the locking part 41 therebetween. The rear part 46 of the arm body 39 is made thinner in the up-down direction than the front part 45 of the arm body 39 and is disposed parallelly opposing the center-side upper surface part 32 when the locking arm 31 is in a natural state. Note that the free end portion 42 is included in the rear part 46.

The unlocking operation part 43 is coupled to the upper surface of the rear part 46 of the arm body 39. As shown in FIGS. 2 and 3, the unlocking operation part 43 has a square-tubular shape and has a through hole 47 that passes through in the front-back direction. As shown in FIG. 3, the locking part 41 is visible from the rear through the through hole 47. On the upper surface of the unlocking operation part 43 is formed a flat pressing surface 48 in the front-back direction and left-right direction. The pressing surface 48 of the unlocking operation part 43 is disposed exposed rearward of the evacuation part 37 of the covering wall part 35. The locking arm 31 can be unlocked by the pressing surface 48 being pressed from above.

As shown in FIGS. 3 and 4, a contacting part 51 is provided on the upper surface of the housing body 28. This contacting part 51 has a rib shape extending in the left-right direction and protrudes from the center-side upper surface part 32 of the housing body 28. The upper surface of the contacting part 51 has an abutting surface 52 in the front-back direction and the left-right direction. When the locking arm 31 is in a natural state, the abutting surface 52 of the contacting part 51 is disposed parallelly opposing the lower surface of the free end portion 42 of the arm body 39 with a gap between the abutting surface 52 and the lower surface of the free end portion 42. The abutting surface 52 of the contacting part 51 comes in contact with the lower surface of the free end portion 42 of the arm body 39 in a surface contact or line contact state during the process of mating the housing 20 and the partner housing 80. As shown in FIG. 2, an extraction hole 53 is formed passing through an intermediate portion of the base end portion 38 in the left-right direction at a position facing the contacting part 51. The contacting part 51 is visible from the front through the extraction hole 53 (see FIG. 3). This extraction hole 53 has a rectangular cross-sectional shape (cross-sectional shape obtained by projecting contacting part 51) and is formed by extracting a mold (not shown) that shapes the front surface of the contacting part 51.

### Operation of Connector

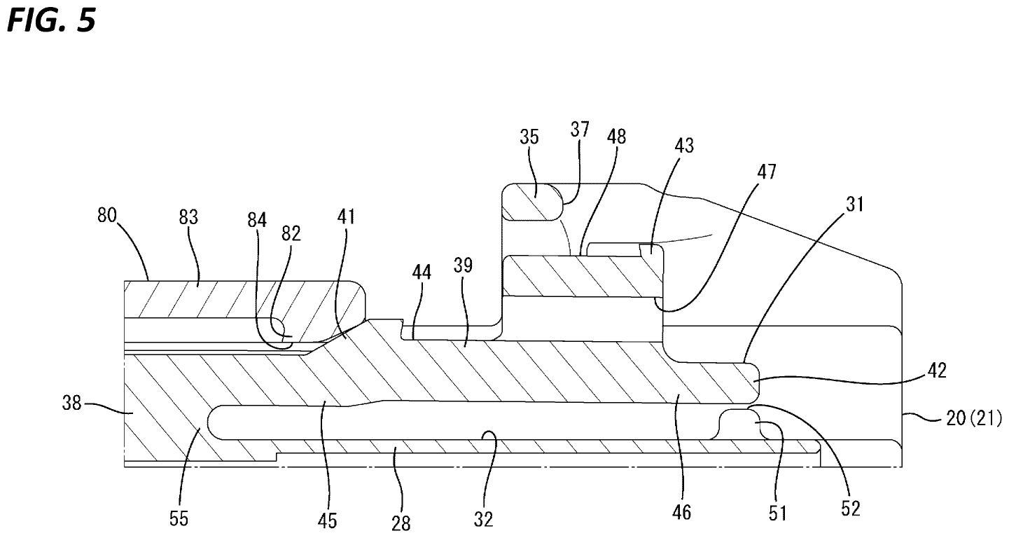

When starting the task of mating the connector 10, the housing 20 is inserted inside the partner housing 80. In the process of mating the housing 20 to the partner housing 80, the locking part 41 slides due to interfering with the partner locking part 82, the arm body 39 inclines so as to approach the center-side upper surface part 32, and the locking arm 31 is elastically displaced with the front end region 55 as a supporting point. As shown in FIG. 5, at an initial stage when sliding of the locking part 41 and the partner locking part 82 is started, the free end portion 42 of the arm body 39 is spaced away from the contacting part 51, and the base end portion 38 constitutes the only supporting point of the flexing movement. Therefore, at this initial stage, the locking arm 31 does not enter an apparent double-supported beam state, and the elastic reaction force of the locking arm 31 does not become particularly large, thus enabling the mating resistance of the connector 10 to be suppressed.

When mating of the connector 10 proceeds and the sliding movement of the locking part 41 and the partner locking part 82 continues, the arm body 39 inclines closer to the center-side upper surface part 32 than described above, and the locking arm 31 is elastically displaced more than described above. An intermediate portion of the lower surface of the free end portion 42 of the arm body 39 in the left-right direction thereby comes in contact with the abutting surface 52 of the contacting part 51 in the left-right direction, and further lowering of the free end portion 42 is inhibited. Here, the locking arm 31 is supported by the base end portion 38 on the front end side being integrally coupled to the housing body 28 and the free end portion 42 on the rear end side coming in contact with the contacting part 51. In other words, the locking arm 31 is in a double-supported beam state in which the end portions on both front and rear sides are apparently supported by the housing body 28.

As shown in FIG. 6, when the locking part 41 comes in contact with an apex face 84 (lower end face) of the partner locking part 82 and sinks down greatly, the locking arm 31 is elastically displaced to the maximum, and is elastically displaced in an arched shape with the front end region 55 (coupling region of base end portion 38 and front end side of housing body 28) and the rear end region 56 (contact region of free end portion 42 and contacting part 51) as supporting points. The rear end region 56 permits sliding displacement of the free end portion 42 and the contacting part 51, and thus is not a fixed end, unlike the front end region 55. Therefore, the elastic reaction force of the locking arm 31 is larger than the elastic reaction force of the locking arm 31 in a cantilever beam state in which the rear end region 56 does not come in contact with the housing body 28, but is smaller than the elastic reaction force of the locking arm 31 in a double-supported beam state in which both sides in the front-back direction are fixed ends.

Also, during the elastic displacement of the locking arm 31 described above, stress acting on the locking arm 31 is distributed between the front end region 55 and the rear end region 56, rather than being concentrated in the front end region 55.

Thereafter, when the locking part 41 passes through the apex face 84 of the partner locking part 82, the locking arm 31 is elastically displaced in the return direction, and the arm body 39 rises toward its original horizontal posture. In the case of the first embodiment, the free end portion 42 remains in contact with the abutting surface 52 of the contacting part 51, as shown in FIG. 7. Then, when the locking part 41 reaches the position where it can lock the partner locking part 82, the housing 20 and the partner housing 80 are held in the mated state. At this time, the striking surface 44 of the arm body 39 hits the apex face 84 of the partner locking part 82 and produces a locking sound. Therefore, the fact that the housing 20 and the partner housing 80 have mated can be audibly detected. Also, the operator is able to obtain a favorable locking feel, as a result of the locking arm 31 in the apparent double-supported beam state being locked by the locking part 41 with an appropriate elastic reaction force.

In order to separate the housing 20 and the partner housing 80 in the mated state, the pressing surface 48 of the unlocking operation part 43 is pressed from above, and the unlocking operation part 43 is pressed down. An intermediate portion of the arm body 39 in the front-back direction moves downward as a result, and the locking arm 31 is elastically displaced with the front end region 55 and the rear end region 56 as supporting points (see FIG. 6). Because the unlocking operation part 43 is disposed between the front end region 55 and the rear end region 56 (contacting part 51) in the front-back direction, the unlocking operation part 43 is able to sink down with the free end portion 42 of the locking arm 31 in contact with the abutting surface 52 of the contacting part 51. The locking part 41 is thus spaced away from the partner locking part 82, with the locking arm 31 elastically displaced in an apparent double-supported beam state. The housing 20 and the partner housing 80 can be separated, by moving the housing 20 and the partner housing 80 apart from each other in this state apart.

According to the first embodiment, in the process of mating the housing 20 and the partner housing 80, stress acting on the locking arm 31 is distributed between the front end region 55 (base end portion 38 side) and the rear end region 56 (free end portion 42 side), and thus concentration of stress on only the base end portion 38 side can be avoided. As a result, situations such as where the base end portion 38 breaks can be prevented, even if the connector 10 is miniaturized.

Also, because the free end portion 42 of the arm body 39 comes in contact with the contacting part 51 but is not integrated with the contacting part 51, stress acting on the free end portion 42 side can be suppressed, and an excessive increase in the elastic reaction force of the locking arm 31 can be avoided. As a result, a favorable locking feel can be obtained when the housing 20 and the partner housing 80 are mated together. In particular, since the contacting part 51 protrudes from the center-side upper surface part 32 of the housing body 28, the timing at which the free end portion 42 of the arm body 39 comes in contact with the contacting part 51 and the contact resistance between the free end portion 42 and the contacting part 51 can be easily adjusted simply by, for instance, changing the amount by which the contacting part 51 protrudes.

Also, since the contacting part 51 comes in contact with the free end portion 42 from a state in which the arm body 39 is elastically displaced on the center-side upper surface part 32 side in the process of mating the housing 20 and the partner housing 80, the mating resistance of the connector 10 can be suppressed while the free end portion 42 of the arm body 39 is in contact with the contacting part 51.

Furthermore, since the arm body 39 has the unlocking operation part 43 that protrudes upwardly between the free end portion 42 and the locking part 41 in the front-back direction, the operation of unlocking the locking arm 31 can be performed without hindrance.

### Other Embodiments of Disclosure

The first embodiment disclosed herein is to be considered in all respects as exemplary and not restrictive.

In the case of the first embodiment, the base end portion of the locking arm is coupled to the center-side upper surface part on the upper surface of the housing body. Alternatively, according to another embodiment, the base end portion of the locking arm may be coupled to a pair of side surface portions that oppose each other in the left-right direction between the center-side upper surface part and the edge-side upper surface parts of the housing body, or opposing surfaces of the sidewall parts may be coupled together.

In the case of the first embodiment, the free end portion of the arm body comes in contact with the abutting surface of the contacting part, with the housing mated to the partner housing. Alternatively, according to another embodiment, the free end portion of the arm body may be spaced away from the abutting surface of the contacting part, with the housing mated to the partner housing.

In the case of the first embodiment, the contacting part protrudes from the upper surface of the housing body. Alternatively, according to another embodiment, the contacting part may be formed on the upper surface of the housing body so as to be flat rather than protrude or so as to be recessed.

In the case of the first embodiment, the housing is constituted to be separable into the upper-side housing and the lower-side housing. In contrast, according to another embodiment, the housing may be integrated housing that is not separable into an upper-side housing and a lower-side housing. In the integrated housing, the housing body may be constituted by a portion that excludes the locking arm.

### LIST OF REFERENCE NUMERALS

10 Connector
20 Housing
21 Upper-side housing
22 Lower-side housing
23 Cavity
23A Cavity in center in left-right direction
23B Cavity on both left-right sides
24 Lance
25 Retainer part
26 Locking piece
27 Locking rib
28 Housing body
29 Mating recessed part
31 Locking arm
32 Center-side upper surface part
33 Edge-side upper surface part
34 Sidewall part
35 Covering wall part
36 Blocking wall
37 Evacuation part
38 Base end part
39 Arm body
41 Locking part
42 Free end part
43 Unlocking operation part
44 Striking surface
45 Front part
46 Rear part
47 Through hole
48 Pressing surface
51 Contacting part
52 Abutting surface
53 Extraction hole
55 Front end region
56 Rear end region
60 Terminal fitting
61 Box part
62 Barrel part
70 Electrical wire
80 Partner housing
82 Partner locking part
83 Upper wall
84 Apex face
85 Partner terminal fitting
86 Terminal connecting part
100 Circuit board cm 1. A connector comprising a housing mateable to a partner housing,
wherein the housing includes:
   an elastically displaceable locking arm that holds the partner housing and the housing in a mated state; and
   a housing body having one surface opposing the locking arm in a direction in which the locking arm is elastically displaced in a process of mating the housing and the partner housing, and
where a front side is a front side in a mating direction of the housing to the partner housing, the locking arm includes:
   a base end portion coupled to an end portion of the housing body on the front side;
   an arm body extending rearwardly from the base end portion in a cantilever manner and having a free end portion on a rear end side; and
   a locking part provided in an intermediate portion of the arm body in a front-back direction and lockable to a partner locking part of the partner housing,
the housing body includes, on the one surface, a contacting part that comes in contact with the free end portion of the arm body in the mating process, and
the arm body includes an unlocking operation part protruding on an opposite side to the one surface side, between the contacting part and the locking part in the front-back direction.

2. The connector according to claim 1,
wherein the contacting part is configured to come in contact with the free end portion from a state in which the arm body is elastically displaced on the one surface side in the mating process.

3. The connector according to claim 1,
wherein the contacting part protrudes from the one surface.

4. The connector according to claim 1,
wherein where a left-right direction is a direction orthogonal to both a direction in which the locking arm is elastically displaced and the front-back direction, an intermediate portion of the free end portion of the arm body in the left-right direction comes in contact with the contacting part in the left-right direction in the mating process.
